(19) United States
(12) Patent Application Publication
(10) Pub. No.: US 2014/0113650 A1
(43) Pub. Date: Apr. 24, 2014

(54) SYSTEM AND A METHOD FOR THE DELIVERY OF INFORMATION DATA FROM A SERVER TO A MOBILE DEVICE

(71) Applicants: Yann MAC GARRY, Pleumeur Bodou (FR); Frederic VISTICOT, Chatenay-Malabry (FR); Christophe HENRY, Pleumeur Bodou (FR); Sophie TRON, Paris (FR)

(72) Inventors: Yann MAC GARRY, Pleumeur Bodou (FR); Frederic VISTICOT, Chatenay-Malabry (FR); Christophe HENRY, Pleumeur Bodou (FR); Sophie TRON, Paris (FR)

(21) Appl. No.: 13/655,020

(22) Filed: Oct. 18, 2012

(51) Int. Cl. H04W 24/00

(52) U.S. Cl. 455/456.1

(57) ABSTRACT

In one embodiment, the system includes a plurality of distributed wireless communication terminals. Each wireless communication terminal is configured to advertise an identification signal that uniquely identifies the terminals. At least one mobile wireless communication device is configured to detect the communication terminals within a proximal distance thereof. The mobile wireless communication device is configured to communicate wirelessly with a stationary information processing device. The stationary information processing device is configured to send the communication device information data according to desired criteria.

### BACKGROUND OF THE INVENTION

The present invention relates to a system for the delivery of information data.

We know of distributed arrangements of devices broadcasting information around an environment, such as for asset tracking in warehouses, or geo-localised marketing.

In these arrangements, powered devices are arranged at locations, and are networked to a central server. The server is configured to push certain information, for example marketing information, via certain terminals to compatible user handset able to communicate with the terminals. This is one way of pushing an advertising message at a known location.

Similarly for asset tracking purposes, a central server broadcasts to a particular device, associated with a known stock-keeping-unit (SKU), its identity in such a way that warehouse personnel searching for the particular SKU will be notified when they are in proximity of the SKU.

However, the installation of such a network of devices in communication with a central computer is complicated and requires a lot of installation effort.

### SUMMARY OF THE INVENTION

At least one embodiment is directed to a system for the delivery of information data.

In one embodiment, the system includes a plurality of distributed wireless communication terminals. Each wireless communication terminal is configured to advertise an identification signal that uniquely identifies the terminals. At least one mobile wireless communication device is configured to detect the communication terminals within a proximal distance thereof. The mobile wireless communication device is configured to communicate wirelessly with a stationary information processing device. The stationary information processing device is configured to send the communication device information data according to desired criteria.

At least another embodiment is directed to a method of delivering information data to a mobile wireless communication device.

In one embodiment of the method, the wireless communication device operates in a system having a stationary information processing device in wireless communication with the mobile wireless communication device. The system further includes a plurality of distributed communication terminals. The method includes listening, by the wireless communication device, for advertising broadcast from communication terminals; storing, by the mobile communication device, information relative to the communication terminal found, the information including at least a unique identifier; transmitting, by the mobile communication device, information found on the communication terminal to said information processing device; and receiving, by the mobile communication device, returned information data from the processing device, the received returned information data having been returned according to predetermined criteria.

Advantages in some embodiments is to allow for the low cost distribution of terminals around an environment, and leverage existing communication networks and devices for the processing and distribution of information to specific users.

### BRIEF DESCRIPTION OF THE DRAWINGS

Some embodiments of devices and methods in accordance with embodiments of the present invention are now described, by way of example only, and with reference to the accompanying drawings, in which:

FIG. 1 illustrates contextually a communication system according to an embodiment of the present invention, and

FIG. 2 illustrates contextually the communication flows between components of a system according to an embodiment of the present invention.

### DETAILED DESCRIPTION

At least one example embodiment will now be described more fully with reference to the accompanying drawings in which some example embodiments are shown.

Detailed illustrative embodiments are disclosed herein. However, specific structural and functional details disclosed herein are merely representative for purposes of describing at least one example embodiment. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term mobile wireless communication device may be considered synonymous to, and may hereafter be occasionally referred to, as a terminal, mobile, mobile unit, mobile station, mobile user, user equipment (US), access terminal (AT), subscriber, user, remote station, access terminal, receiver, etc., and may describe a remote user of wireless resources in a wireless communication network.

Exemplary embodiments are discussed herein as being implemented in a suitable computing environment. Although not required, exemplary embodiments will be described in the general context of computer-executable instructions, such as program modules or functional processes, being executed by one or more computer processors or CPUs. Generally, program modules or functional processes include routines, programs, objects, components, data structures, etc. that performs particular tasks or implement particular abstract data types.

The program modules and functional processes discussed herein may be implemented using existing hardware in existing communication networks. For example, program modules and functional processes discussed herein may be implemented using existing hardware at existing network elements or control nodes. Such existing hardware may include one or more digital signal processors (DSPs), application-specific-integrated-circuits (ASICs), field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

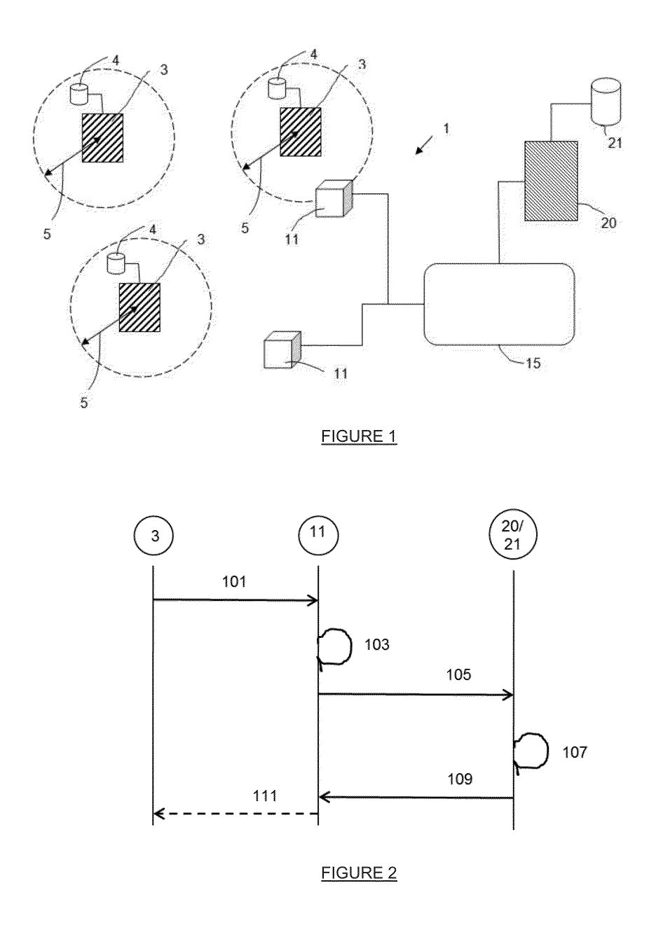

FIG. 1 illustrates a communication environment 1, otherwise known as a communication system 1, in which is distributed a plurality of communication terminals 3.

The communication terminals 3 may have processing capabilities (e.g., include one or more processors) and have wireless communication capabilities, for example radio-frequency (RF), Near Field Communication (NFC), Wi-fi®, Bluetooth, or other near-field wireless communication protocols. In particular, the communication terminals have a communication range 5 of less than thirty meters. In other words, a communication device needs to be within thirty meters of the communication terminal for it to be possible to establish a communication session. Preferably, the communication range 5 is less than one meter, and even more preferably less than thirty centimeters.

Each communication terminal 3 however comprises a storage component 4 (e.g., solid state memory, hard drive, etc.) having a unique terminal identifier or other unique identifying information (known for example under the term TagId). In a variant in which the communication terminal 3 is a passive device, the terminal identifier is only transmitted when powered by an external device. The terminal identifier of each terminal 3 is broadcast, or “advertised” as it is known in the art at all times.

In some embodiments, the storage component 4 may further comprise additional information, such as a message, a video file, a data file, or otherwise, that may be diffused alongside the TagId, or exchanged subsequent a successful pairing between the terminal 3 and a pairing device. By pairing, one understands the establishment of a communication session.

In some embodiments, the communication terminals 3 may be passive devices. More particularly, communication terminals may not be self-powered, and must be energized by a master device by, for example, the generation of an electromagnetic field, for example an RF field. In this case, the terminal unique identifier is advertised when energized by a master device.

Moreover, in some embodiments the storage component 4 may have information pertaining to the communication terminals own location. This information may be of the form of GPS information (eg. 38.870973, −77.055928), descriptive (eg. “one foot north east of the chocolate stand”), or general (eg. “lipstick stand”).

The communication terminals 3 are standalone devices with otherwise no further communication link with the environment 1. Preferentially, the communication terminals are static, to be understood that they do not readily change location in the environment 1, but the invention is not limited to this advantageous feature.

The system 1 further comprises at least one mobile wireless communication device 11 having an internal power source such as a battery. The mobile communication device 11 may be for example a mobile phone held by a user. It will be understood that the embodiment is not limited to this example of a mobile wireless communication device 11.

The communication device 11 is configured to enter in a communication exchange with any of the communication terminals 3 when the communication device 11 is communication range 5 amenable for coherent communication.

Furthermore, the communication device 11 comprises a further communication interface operable for communicating via a mobile communication protocol to a public communication network 15, such as internet. This communication may occur via a wireless network (not shown) as is well known.

The system 1 further comprises a server device 20 also in communication exchange with the public communication network 15.

In some embodiments, the communication channel established between the communication device 11 and the service is secured and/or encrypted.

The server 20 comprises a storage component 21 (e.g., solid state memory, hard drive, etc.).

The storage component 21 is configured to store, for example:
communication devices 11 able or authorized to interact with the server 20,
localization information of some or all of communication terminals 3, and/or
informational messages, eg advertising messages.

The server 20 may further be loaded with rules for distinguishing which devices 11 it may interact with, or to which devices to send a particular informational message, or according to which criteria, eg according to position as returned by a device 11.

FIG. 2 illustrates the operation of the system 1 according to an embodiment.

The communication terminal 3 is a powered Bluetooth terminal advertising (i.e., broadcasting) its presence by sending its identify information, i.e., TagId.

Once a Bluetooth compatible communication device 11 comes in proximity of the communication device, the communication device 11 will detect the terminal 3 advertising its TagId to the Bluetooth device 11 (step 101).

At step 103, the communication device 11 reads the identity information of the communication terminal 3. In some embodiments, the communication device 11 may also read the position information embedded in the terminal 3 as well as any other information messages present.

Note that it is not required, though it is possible, for the communication device 11 to establish a communication between themselves—i.e., for the devices to pair.

With this collected information, the mobile device 11 sends (step 105) this information to the server 20. The transmission may be performed over a secured communication network 15 or not.

The server 20 will inquire (step 107) in the storage component 21 to see what the terminal identifier coordinates correspond to.

During this step, the server 20 may also update the position information of the communication terminal 3 if need be.

During this step, the server 20 will furthermore follow desired (or, alternatively predetermined) rules in determining a message or a data cluster to send back to the mobile device 11 (step 109).

Data cluster may mean application data, executable file data, or otherwise structured data.

In some embodiments, step 107 may be used to send information to the communication terminal 3 via the mobile device 11. For example, in step 107, the server 20 may update a message advertised by the terminal 3. In these variants, a supplemental step 111 allows the mobile device 11 to update the terminal storage 4.

A person of skill in the art would readily recognize that steps of various above-described methods can be performed by programmed computers.

Herein, some embodiments are intended to cover program storage devices, e.g., digital data storage media, which are machine or computer readable and encode machine-executable or computer-executable programs of instructions where the device executing the instructions is a specific purpose machine performing some or all of the steps of methods described herein. The program storage devices may be, e.g., digital memories, magnetic storage media such as a magnetic disks or tapes, hard drives, or optically readable digital data storage media. The embodiments are also intended to cover computers or processors programmed to perform said steps of methods described herein.

The present inventions may be embodied in other specific apparatus and/or methods. The described embodiments are to be considered in all respects as only illustrative and not restrictive. In particular, the scope of the invention is indicated by the appended claims rather than by the description and figures herein. All changes that come within the meaning and range of equivalency of the claims are to be embraced within their scope.

1. A system for the delivery of information data, said system comprising:
a plurality of distributed wireless communication terminals, each wireless communication terminal configured to advertise an identification signal that uniquely identifies said terminals; and
at least one mobile wireless communication device configured to detect said communication terminals within a proximal distance thereof, said mobile wireless communication device configured to communicate wirelessly with a stationary information processing device,
wherein said stationary information processing device is configured to send information data to the communication device according to desired criteria.

2. The system according to claim 1, wherein the wireless communication terminals are unpowered and are only operable when energized by a communication device stimulus.

3. The system according to claim 1, wherein said information data is sent to the communication device from the processing device as a function of the identifier information detected by the mobile communication device.

4. The system according to claim 1, wherein the communication terminals are independent and only communicate with compatible wireless communication devices.

5. A method of delivering information data to a mobile wireless communication device operating in a system comprising a stationary information processing device in wireless communication with said mobile wireless communication device, said system further comprising a plurality of distributed communication terminals, said method comprising:
listening, by the mobile communication device, for advertising broadcast from communication terminals;
storing, by the mobile communication device, information relative to the communication terminal found, the information including at least a unique identifier;
transmitting, by the mobile communication device, information found on the communication terminal to said information processing device; and
receiving, by the mobile communication device, returned information data from the processing device, the received returned information data having been returned according to desired criteria.

6. The method according to claim 5, wherein the received returned information data has been returned as a function of the unique identifier.

7. The method according to claim 5, wherein communication throughout the system is encrypted end-to-end.

8. A mobile wireless communication device configured to,
listen for advertising broadcast from communication terminals,
store information relative to the communication terminal found, the information including at least a unique identifier,
transmit information found on the communication terminal to said information processing device, and
receive returned information data from the processing device, the received returned information data having been returned according to desired criteria.
